(19) United States
(12) Patent Application Publication
(10) Pub. No.: US 2018/0253271 A1
(43) Pub. Date: Sep. 6, 2018

(54) INFORMATION PROCESSING DEVICE, TAPE PRINTING APPARATUS, AND EDITING METHOD OF INFORMATION PROCESSING DEVICE

(71) Applicant: SEIKO EPSON CORPORATION, Tokyo (JP)

(72) Inventor: Masahiro OIDA, Matsumoto-shi (JP)

(73) Assignee: Seiko Epson Corporation, Tokyo (JP)

(21) Appl. No.: 15/758,041

(22) PCT Filed: Aug. 31, 2016
(86) PCT No.: PCT/JP2016/003982

§ 371 Date: Mar. 7, 2018

(30) Foreign Application Priority Data
Sep. 11, 2015 (JP) 2015-179907

(51) Int. Cl. G06F 3/12; B41J 2/32; B41J 3/407; B41J 29/393

(52) U.S. Cl. CPC G06F 3/1257; B41J 2/32; G06F 3/1251; B41J 29/393; G06F 3/1204; B41J 3/4075

(57) ABSTRACT

A tape printing apparatus includes a storing unit that stores medium information showing a classification or an identifier of a tape and a user setting that includes edit data in association with one another in an information storage region, a medium information acquisition unit that acquires medium information of a printing medium that is a printing target, an editing unit that retrieves the user setting associated with the acquired medium information from the information storage region and reflects the user setting in the edit data, and a printing unit that performs printing on the tape on the basis of an editing result of the editing unit.

### CROSS REFERENCE TO RELATED APPLICATIONS

This application is a National Stage Entry of PCT/JP2016/003982, filed Aug. 31, 2016; which claims priority to Japanese Patent Application No. 2015-179907 filed on Sep. 11, 2015, the entire contents of both of which are incorporated by reference herein.

### TECHNICAL FIELD

The present invention relates to an information processing device that has a retrieval function of edit data, a tape printing apparatus, and an editing method of an information processing device.

### BACKGROUND ART

For example, NPL 1 is known as this kind of technology. NPL 1 discloses a function in which edit data is stored as a file, and the edit data is retrieved by stipulating a file number. The use of this kind of retrieval function is useful in a case of repeatedly printing the same content.

### CITATION LIST

### Non Patent Literature

NPL 1: “TEPRA” PRO SR55 User Manual, February 2014, First Edition, King Jim Co., Ltd., pages 60-61

### SUMMARY OF INVENTION

### Technical Problem

It should be noted that a retrieval function such as that mentioned above has the following problem. If a tape width of a tape mounted when edit data is retrieved is smaller than a tape width estimated when edit data is created, printing is not possible due to insufficient tape width. Therefore, it is necessary for a user to examine whether or not printing is possible by checking the settings of edit data, performing a test print, or the like, after retrieving a file. In addition, in a case in which printing is not possible, the additional labor of editing the edit data again, searching for another file, or the like, is necessary. In this manner, a function that retrieves edit data that a user edited is extremely useful for the purpose of performing editing work, but there are cases in which, contrary to the intention of a user, printing is not possible, and an improvement is desired.

In the light of the above-mentioned problem, an object of the invention is to provide an information processing device that is capable of preventing a defect in which, contrary to the intention of a user, printing is not possible in a case in which a retrieval function of edit data is used, a tape printing apparatus, and an editing method of an information processing device.

### Solution to Problem

An information processing device of the invention includes a storing unit that stores medium information showing a classification or an identifier of a printing medium and a user setting that includes edit data in association with one another in an information storage region, a medium information acquisition unit that acquires medium information of a printing medium that is a printing target, and an editing unit that retrieves the user setting associated with the acquired medium information from the information storage region and reflects the user setting in the edit data.

A tape printing apparatus of the invention includes a storing unit that stores medium information showing a classification or an identifier of a tape and a user setting that includes edit data in association with one another in an information storage region, a medium information acquisition unit that acquires medium information of a tape that is a printing target, an editing unit that retrieves the user setting associated with the acquired medium information from the information storage region and reflects the user setting in the edit data, and a printing unit that performs printing on the tape on the basis of an editing result of the editing unit.

An editing method of an information processing device of the invention includes a storing step of storing medium information showing a classification or an identifier of a printing medium, and a user setting that includes edit data in association with one another in an information storage region, a medium information acquisition step of acquiring the medium information of the printing medium that is a printing target at a time at which a first trigger occurs, and an editing step of retrieving the user setting associated with the acquired medium information from the information storage region and reflecting the user setting in the edit data.

In the invention, medium information and a user setting that includes edit data are stored in association with one another, and when performing editing work, the user setting associated with the medium information of a printing medium that is a printing target is retrieved and the user setting in the edit data is reflected. According to this configuration, in a case of a tape printing apparatus, since edit data that is suited to a mounted tape is retrieved during editing work, a defect in which, contrary to the intention of a user, printing is not possible due to insufficient tape width, or the like, is not caused. In addition, since it is possible to retrieve edit data by merely exchanging a tape, it is possible to shorten editing work time. In addition, as a result of this, it is possible to reduce printing errors, and it is possible to suppress uneconomical tape consumption.

In the information processing device, the medium information acquisition unit acquires the medium information of the printing medium that is a printing target at a time at which a first trigger occurs, and is provided with a retrieval setting unit that sets necessity of retrieving the user setting, and the editing unit retrieves the user setting in accordance with the occurrence of the first trigger in a case in which retrieval “required” is set by the retrieval setting unit.

According to the configuration of the invention, it is possible to set whether or not to retrieve the user setting when the first trigger occurs in accordance with a preference of a user.

Furthermore, in addition to being capable of setting the necessity of retrieval, the retrieval setting unit may be capable of setting the timing (the first trigger) at which the user setting is retrieved.

In the information processing device, the medium information acquisition unit acquires the medium information of the printing medium that is a printing target at a time at which a second trigger occurs, and the storing unit stores the user setting that includes edit data of the editing unit at a time at which the second trigger occurred, and the medium information acquired at a time at which the second trigger occurred in association with one another.

In the invention, a user setting that includes edit data and medium information at a time at which the second trigger occurred are stored in association with one another in accordance with the occurrence of the second trigger. As a result of this configuration, for example, by configuring such that the second trigger is set to be when printing is executed, it is possible to perform automatic storing without requiring action by a user. In addition, for example, by configuring such that the second trigger is during a predetermined operation by a user, it is possible to store edit data desired by the user.

The information processing device further includes a store setting unit that sets necessity of storing by the storing unit, and the storing unit stores the user setting and the medium information in association with one another in a case in which storing “required” is set by the store setting unit.

According to the configuration of the invention, it is possible to set whether or not to store the user setting and the medium information when the second trigger occurs in accordance with a preference of a user.

Furthermore, in addition to being capable of setting the necessity of storing, the store setting unit may be capable of setting the timing (the second trigger) at which the user setting and the medium information are stored.

In the information processing device, the user setting includes an environment setting value at a time at which the second trigger occurred.

According to the configuration of the invention, it is also possible to store, as a portion of the user setting, an environment setting value that is set in the information processing device at a time at which the second trigger occurred.

In the information processing device, the medium information shows a classification of the printing medium, and the classification of the printing medium is classified by at least one type of information from among a size of the printing medium, a color of the printing medium, a material of the printing medium, or a printing color that can be printed on the printing medium.

According to the configuration of the invention, a user setting is stored for each classification of the printing medium, which are classified as a size (width, length, or the like) of the printing medium, a color of the printing medium, a material of the printing medium, and a printing color that can be printed on the printing medium, and it is possible to retrieve the user setting using the classification as a key.

### BRIEF DESCRIPTION OF DRAWINGS

FIG. 1 is an external perspective view of a tape printing apparatus.

FIG. 2 is a block diagram that shows a hardware configuration of the tape printing apparatus.

FIG. 3 is a block diagram that shows a functional configuration of the tape printing apparatus.

FIG. 4 is an explanatory view of a store file.

FIG. 5 is a screen transition diagram that shows a user setting store operation.

FIG. 6 is a screen transition diagram that continues from FIG. 5.

FIG. 7 is a screen transition diagram that continues from FIG. 6.

FIG. 8 is a screen transition diagram that shows a user setting retrieval operation.

FIG. 9 is a screen transition diagram that continues from FIG. 8.

FIG. 10 is a screen transition diagram that continues from FIG. 9.

FIG. 11 is a view that shows an example of a retrieval confirmation screen.

FIG. 12 is a flowchart that shows a flow of a user setting store process.

FIG. 13 is a flowchart that shows a flow of a user setting retrieval process.

FIG. 14 is a block diagram that shows a functional configuration of a printing system according to a second embodiment.

FIG. 15 is a view that shows a display example of an entire print history that is stored in the tape printing apparatus.

FIG. 16 is a view that shows a display example of a print history that is extracted by tape classification.

### DESCRIPTION OF EMBODIMENTS

### First Embodiment

Hereinafter, an information processing device, a tape printing apparatus, and an editing method of an information processing device of the invention will be described with reference to the appended drawings. In the present embodiment, a case in which the information processing device of the invention is applied to a tape printing apparatus will be illustrated by way of example.

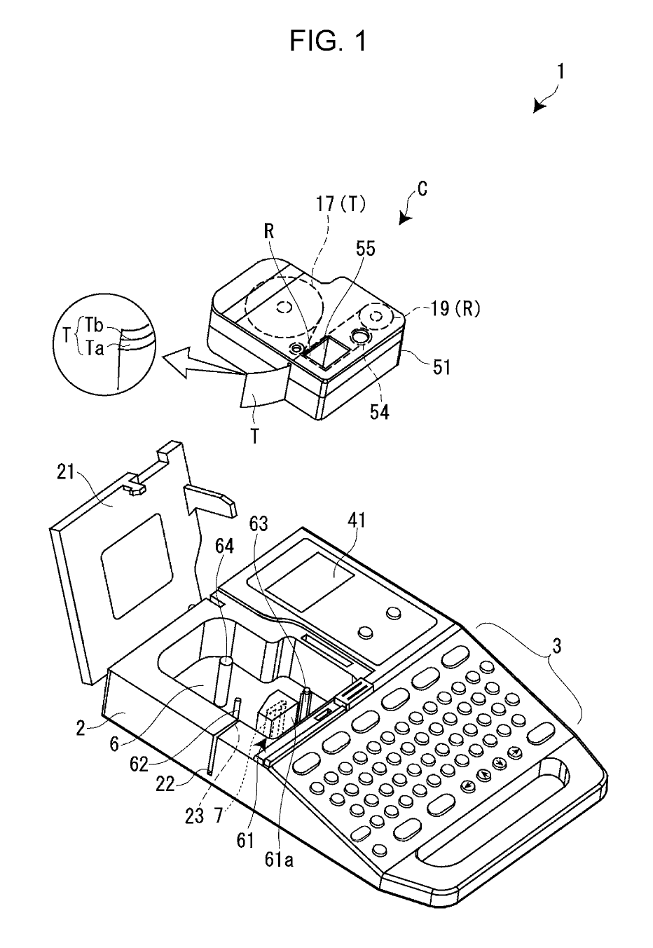

FIG. 1 is an external perspective view of a tape printing apparatus 1. As shown in the drawing, in the tape printing apparatus 1, an outline is formed by an apparatus case 2, a keyboard 3 provided with various input keys and buttons is disposed on the upper surface of a front section of the apparatus case 2, and on the upper surface of a rear section, an opening/closing lid 21 is attached to a left section and a display screen 41 is installed in a right section. A cartridge mounting portion 6 for mounting a tape cartridge C is formed so as to be recessed on the inner side of the opening/closing lid 21, and the tape cartridge C is mounted in the cartridge mounting portion 6 in a state in which the opening/closing lid 21 is open.

A tape ejection outlet 22 that communicates between the cartridge mounting portion 6 and the outside is formed in a left side section of the apparatus case 2, and a tape cutter 23 for cutting printing tape T fed out by a tape transport mechanism, which is not illustrated in the drawings, faces the tape ejection outlet 22. Further, a predetermined length of the printing tape T on which printing has been performed is fed out from the tape ejection outlet 22, is cut by the tape cutter 23 in a state in which feeding is temporarily stopped, and a strip-form label (not illustrated in the drawings) is created.

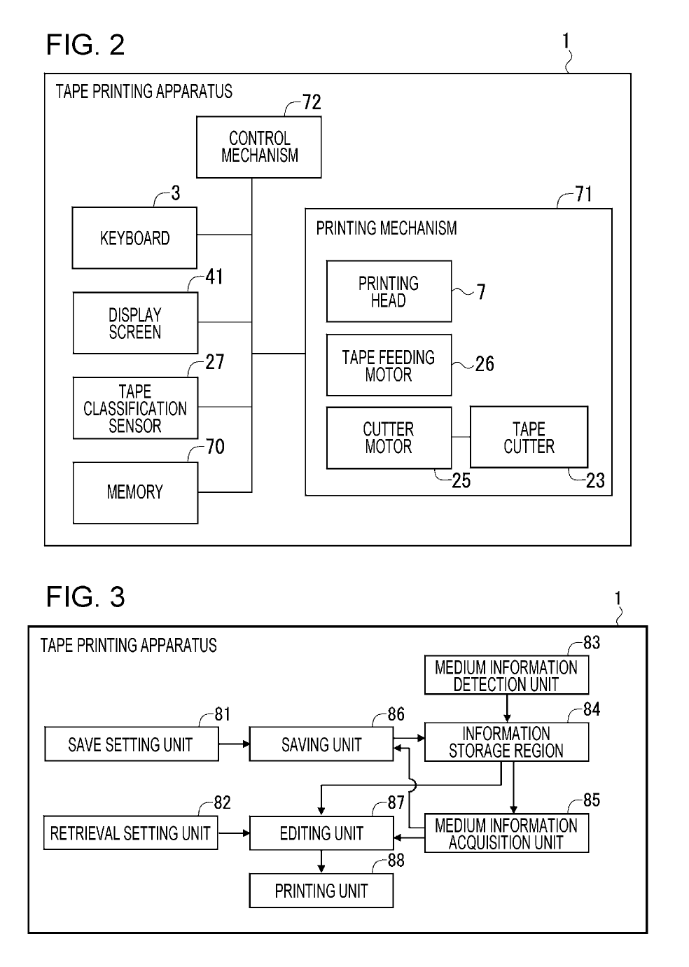

Meanwhile, the cartridge mounting portion 6 is provided with a head unit 61 in which a thermal type printing head 7 is built into a head cover 61a, a platen drive shaft 62 that opposes the printing head 7, a wind-up drive shaft 63 that winds up an ink ribbon R, which will be mentioned later, and a positioning projection 64 of a tape reel 17, which will be mentioned later. In addition, a tape feeding motor 26 (refer to FIG. 2) that causes the platen drive shaft 62 and the wind-up drive shaft 63, which are tape transport mechanisms, to rotate is built into the lower side of the cartridge mounting portion 6.

The tape cartridge C is configured to accommodate the tape reel 17, in which the printing tape T of a predetermined width is wound, in a central section of an upper section of the inside of a cartridge case 51, and a ribbon reel 19, in which the ink ribbon R is wound, in a lower right section. In addition, a through-hole 55 for the head cover 61a, which covers the head unit 61, to be inserted into is formed in a lower left section of the tape reel 17. In addition, a ribbon wind-up reel 54 is disposed in proximity to the ribbon reel 19, and the ink ribbon R reeled out from the ribbon reel 19 is wound up onto the ribbon wind-up reel 54 so as to orbit the head cover 61a.

Meanwhile, the printing tape T is composed of a recording tape Ta in which an adhesive layer is formed on the rear surface and a release tape Tb, is wound around in a rolled form with the recording tape Ta outer side, and is accommodated inside the cartridge case 51. In addition, regarding the printing tape T, a plurality of kinds having different tape classifications are available, and one of these kinds of printing tape T (and the ink ribbon R) is accommodated in each cartridge case 51.

Next, a hardware configuration of the tape printing apparatus 1 will be described with reference to FIG. 2. As a hardware configuration, the tape printing apparatus 1 is provided with the keyboard 3, the display screen 41, a tape identification sensor 27, a memory 70, a printing mechanism 71, and a control mechanism 72.

The keyboard 3 performs the input and editing of text (characters, pictographs, symbols, and the like), insertion and editing of images, and various settings. The display screen 41 displays a text editing screen (not illustrated in the drawings) and various operation screens (refer to FIGS. 5 to 11). The tape identification sensor 27 detects a classification (hereinafter, referred to as “tape classification”, “medium information” in the claims) of the tape cartridge C. In the present embodiment, the tape width, the tape material, and the tape color of the printing tape T, and the ink color of the ink ribbon R are set as detection items, and the combination thereof is detected as the tape classification. In addition to these, whether or not the printing tape T accommodated in the tape cartridge C is for a die cut label, and the label shape thereof may be included in the detection items. Furthermore, in a case of a tape printing apparatus 1 that has a rewind function, whether or not the tape is compatible with the rewind function may be included in the detection items. Additionally, a method that reads an image (a barcode or a two-dimensional code) or a radio frequency identification (RFID) affixed to or printed on the tape cartridge C, a method that detects the presence or absence of one or more holes formed in the tape cartridge C, and the like, can be considered as detection methods.

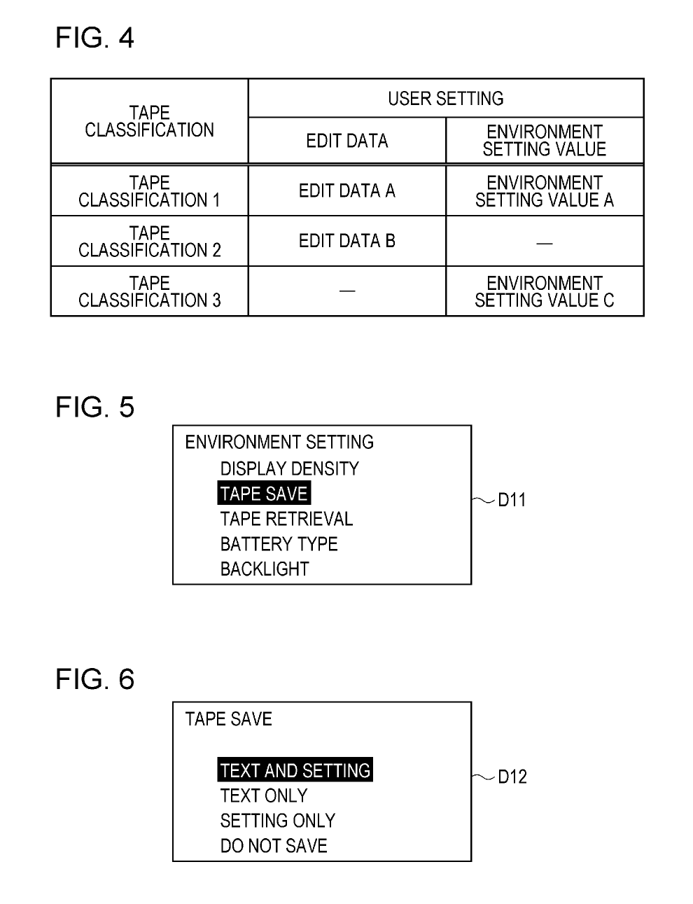

The memory 70 is a nonvolatile storage region, and stores firmware of the tape printing apparatus 1, a store file (refer to FIG. 4), which will be mentioned later, and the like. The printing mechanism 71 includes the printing head 7, the tape feeding motor 26, a cutter motor 25, and the tape cutter 23. The printing head 7 performs printing on the recording tape Ta of reeled out printing tape T. The tape feeding motor 26 transports reeled out printing tape T toward the tape ejection outlet 22 (refer to FIG. 1). The cutter motor 25 drives the tape cutter 23 and cuts a portion of the printing tape T on which printing has been performed.

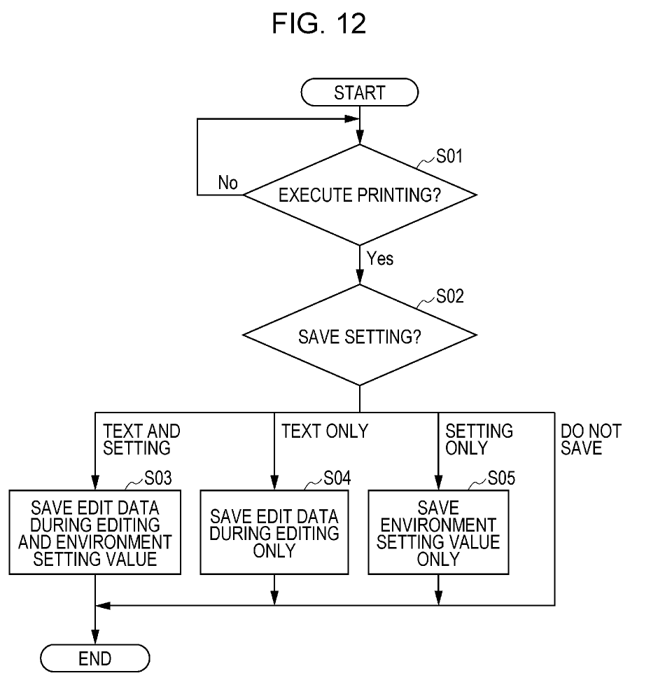

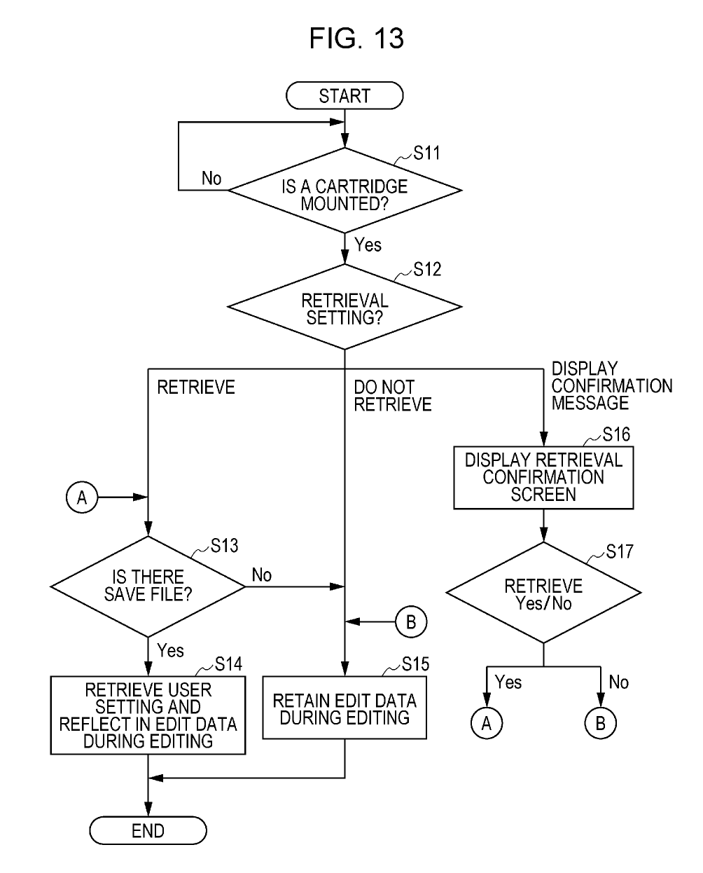

The control mechanism 72 is configured by a central processing unit (CPU), a random access memory (RAM), and the like, and performs an editing process or printing control by cooperating with each unit. Specifically, in the present embodiment, a user setting store process (refer to FIG. 12) in which a user setting that includes edit data and an environment setting value is stored in association with a tape classification, and a user setting retrieval process (refer to FIG. 13) in which a stored user setting is retrieved using a tape classification as a key are controlled. The details of these processes will be mentioned later.

Next, a functional configuration of the tape printing apparatus 1 will be described with reference to FIG. 3. As a functional configuration, the tape printing apparatus 1 is provided with a store setting unit 81, a retrieval setting unit 82, a medium information detection unit 83, an information storage region 84, a medium information acquisition unit 85, a storing unit 86, an editing unit 87, and a printing unit 88.

The store setting unit 81 sets the necessity of storing of a user setting by the storing unit 86 (refer to FIGS. 5 to 7). The retrieval setting unit 82 sets the necessity of retrieving of a user setting (refer to FIGS. 8 to 10). Additionally, the setting values of the store setting unit 81 and the retrieval setting unit 82 are stored in a first region in the information storage region 84. The information storage region 84 is equivalent to the memory 70. Additionally, the first region may be provided in a volatile storage region (RAM).

The medium information detection unit 83 detects the tape classification of the tape cartridge C mounted in the cartridge mounting portion 6 by using the tape identification sensor 27 when a power source of the tape printing apparatus 1 is turned on, when a cartridge is mounted, or when the opening/closing lid 21 is closed. The detected tape classification is stored in a second region in the information storage region 84. In the same manner as the first region, the second region may also be provided in RAM. Additionally, in a case of a configuration in which it is not possible for the tape printing apparatus 1 to detect that the tape cartridge C has been mounted in the cartridge mounting portion 6, mounting of the tape cartridge C may be detected as a result of detection of opening and closing of the opening/closing lid 21.

The medium information acquisition unit 85 acquires the tape classification (medium information) of the tape cartridge C from the second region (or RAM) in the information storage region 84 when the tape cartridge C is mounted (at a time at which a first trigger occurs). In addition, the tape classification of the tape cartridge C is acquired from the second region (or RAM) when printing is executed (at a time at which a second trigger occurs). Although described in more detail later, the medium information acquisition unit 85 retrieves a user setting, or acquires a tape classification when a trigger for the storing of a user setting occurs.

When a tape classification is acquired by the medium information acquisition unit 85 in conjunction with the execution of printing, the storing unit 86 stores the acquired tape classification and the user setting at that time (at a time at which the second trigger occurs) in association with one another in a third region in the information storage region 84 as a store file. In this instance, the “a user setting” include at least edit data (edit data of the editing unit 87) that is displayed on the display screen 41 at a time at which the execution of printing is performed, and an environment setting value that is set in the tape printing apparatus 1 at that time (at a time at which printing is executed).

Additionally, the “edit data” includes text and text settings. Text settings include character mode (typeface, decorative characters, italic, bold, extended and contracted text, boxed text, halftone dot meshing, character interval), paragraph style (vertical script/horizontal script, character size, layout, enclosed, table form), sentence format (constant-length printing, pattern printing, blank spaces), and the like. In addition, the “edit data” also includes images (graphic data) and image settings.

In addition, the “environment setting value” includes the setting items that are shown on the environment setting screen of FIG. 5 (“display density (display density) of the display screen 41”, “tape store”, “tape retrieval”, “battery type (alkaline battery/rechargeable-type nickel hydrogen battery)”, and “backlight (ON/OFF of a backlight of the display screen 41)”). In addition to these items, the “environment setting value” includes tape cutting (presence or absence of automatic tape cutting when printing is finished), printing density, printing speed, printing position in the width direction of the printing tape T, and the like.

Additionally, the storing unit 86 stores the user setting in accordance with the setting of the store setting unit 81. For example, the edit data and the environment setting value are stored in a case in which “text and setting” is set to storing “required” by the store setting unit 81 (a case in which information showing storing of “text and setting” “required” is stored in the first region), and the edit data is stored but the environment setting value is not stored in a case in which “text only” is set to storing “required”. In addition, the environment setting value is stored and the edit data is not stored in a case in which “setting only” is set to storing “required” by the store setting unit 81, and both the edit data and the environment setting value are not stored in a case in which “do not store” is set.

When a tape classification is acquired by the medium information acquisition unit 85 in accordance with mounting of the tape cartridge C, the editing unit 87 retrieves a user setting associated with the acquired tape classification from the third region in the information storage region 84 and reflects the user setting in edit data currently being editing. In this instance, the term “during editing” does not necessarily indicate a state during text being input on an editing screen for performing text editing, and may be a state in which text is not being input on the editing screen. In addition, a configuration that does not reflect the user setting in a case in which the editing screen is not displayed on the display screen 41 (for example, case in which the environment setting screen is displayed, or the like), or a configuration that reflects the user setting at a point in time of switching to the editing screen may be used.

Additionally, the editing unit 87 retrieves a user setting in a case in which retrieval “required” is set by the retrieval setting unit 82 (a case in which information showing retrieval “required” is stored in the first region), and does not retrieve a user setting in a case in which retrieval “not required” is set. Furthermore, in addition to at a time at which a tape classification is acquired when a cartridge is mounted, a user setting is also retrieved at a time at which a retrieval operation is performed by a user (for example, at a time at which “Yes” is selected on a retrieval confirmation screen D24, refer to FIG. 11).

The printing unit 88 performs printing on the printing tape T on the basis of an editing result of the editing unit 87 in accordance with a printing execution operation by a user. Additionally, the storing unit 86 stores a user setting in accordance with the execution of printing by the printing unit 88, but overwrites a user setting in a case in which a store file for the same tape classification is already stored in the third region. In other words, in the third region, only one set of a user setting can be stored as a store file for a single tape classification. Additionally, a trigger (the second trigger) for the storing of a user setting by the storing unit 86 need not necessarily be the execution of printing by the printing unit 88, and may be the pressing down of a printing execution button (not illustrated in the drawings) on the keyboard 3. Alternatively, the completion of printing by the printing unit 88 may be used as the trigger for the storing of a user setting.

Next, a store file will be described with reference to FIG. 4. As mentioned above, a store file is a file in which a “tape classification” and “a user setting” are associated with one another. In addition, “a user setting” indicates at least one of “edit data” and an “environment setting value”. For example, in the store file of the topmost level shown in FIG. 4, “edit data A” and an “environment setting value A” are associated with a “tape classification 1”. Additionally, in the manner of the store file of the middle level, in a case in which only “edit data” is stored as a user setting, even in a case in which the user setting is reflected by the editing unit 87, an environment setting value is not changed (the environment setting value before reflection is retained). In addition, in the manner of the store file of the bottom level, in a case in which only an “environment setting value” is stored as a user setting, even in a case in which the user setting is reflected by the editing unit 87, edit data is not changed (the edit data before reflection is retained). Additionally, in place of not changing the environment setting value, the value may be changed to a default value, and in place of not changing edit data, the editing screen may be returned to an initial state.

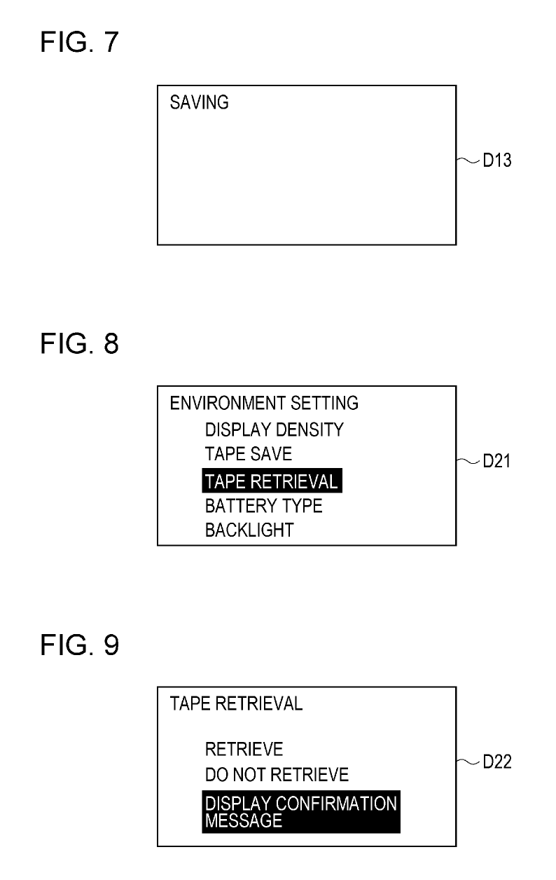

Next, a user setting store operation will be described with reference to the screen transition diagrams of FIGS. 5 to 7. A screen D11 that is shown in FIG. 5 shows a state in which a setting item “tape store” is temporarily selected on the environment setting screen. When a selection is made in the state of the screen D11 (when a confirmation operation is performed), a tape store setting screen D12 that is shown in FIG. 6 is displayed. On the tape store setting screen D12, one option can be selected from the four options of “text and setting”, “text only”, “setting only”, and “do not store” (the store setting unit 81, refer to FIG. 3). When a selection is made in a state in which an arbitrary option among these is selected, a storing screen D13 that is shown in FIG. 7 is displayed, and after a few seconds, the display returns to the screen D11 shown in FIG. 5.

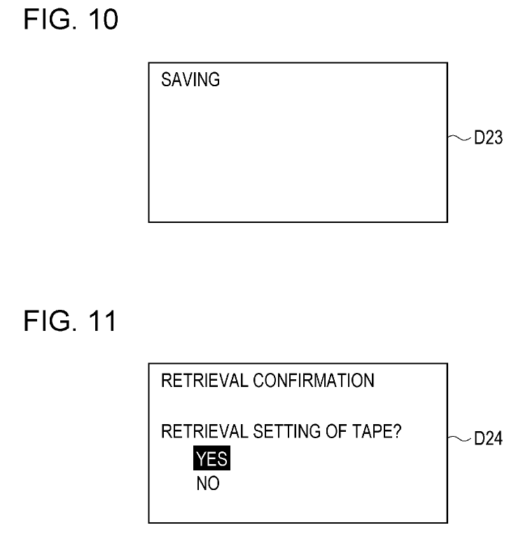

Next, a user setting retrieval operation will be described with reference to the screen transition diagrams of FIGS. 8 to 10. A screen D21 that is shown in FIG. 8 shows a state in which a setting item “tape retrieval” is temporarily selected on the environment setting screen. When a selection is made in the state of the screen D21, a tape retrieval setting screen D22 that is shown in FIG. 9 is displayed. On the tape retrieval setting screen D22, one option can be selected from the three options of “retrieve”, “do not retrieve”, and “display confirmation message” (the retrieval setting unit 82, refer to FIG. 3). When a selection is made in a state in which an arbitrary option among these is selected, a storing screen D23 that is shown in FIG. 10 is displayed, and after a few seconds, the display returns to the screen D21 shown in FIG. 8. Additionally, FIG. 11 shows the retrieval confirmation screen D24 that is displayed using the mounting of the tape cartridge C as a trigger in a case in which the option “display confirmation message” is selected on the tape retrieval setting screen D22. On the retrieval confirmation screen D24, either option of whether to retrieve (“Yes”) or not retrieve (“No”) settings of the tape can be selected.

Next, a flow of a user setting store process will be described with reference to the flowchart of FIG. 12. In the user setting store process, when a printing execution operation is performed by a user (S01: Yes), a store setting (a selection result of the tape store setting screen D12) is determined by referring to the first region in the information storage region 84 (S02). For example, in a case in which the store setting is “text and setting”, edit data and an environment setting value during editing (at a point in time at which the printing execution operation is performed) are stored as a user setting (S03). At this time, the user setting is stored in association with the tape classification acquired from the second region in the information storage region 84 (the same applies to S04 and S05 below). In addition, in a case in which the store setting is “text only”, only edit data currently being edited is stored (S04). In addition, in a case in which the store setting is “setting only”, only an environment setting value at a point in time at which the printing execution operation is performed is stored (S05). Furthermore, in a case in which the store setting is “do not store”, a store operation that accompanies the execution of printing is not performed.

Next, a flow of a user setting retrieval process will be described with reference to the flowchart of FIG. 13. In the user setting retrieval process, when it is detected that the tape cartridge C has been mounted in the cartridge mounting portion 6 (S11: Yes), a retrieval setting (a selection result of the tape retrieval setting screen D22) is determined by referring to the first region in the information storage region 84 (S12). For example, in a case in which the retrieval setting is “retrieve”, it is determined whether or not there is, in the third region in the information storage region 84, a store file that includes the tape classification acquired from the second region in the information storage region 84 (S13). In this instance, in a case in which there is a store file (S13: Yes), the user setting in the store file are retrieved from the third region in the information storage region 84, and are reflected in edit data currently being edited (S14). Additionally, in this instance, in a case in which there is already inputted edit data, a confirmation screen for confirming with a user whether or not it is ok to reflect the user setting may be displayed. In addition, in a case in which there is not a store file (S13: No), edit data currently being edited is retained (S15). Furthermore, edit data currently being edited is also retained in a case in which the retrieval setting is “do not retrieve” (S15).

Meanwhile, in a case in which the retrieval setting is “display confirmation message”, the retrieval confirmation screen D24 (refer to FIG. 11) is displayed (S16), and it is determined which of “Yes” and “No” is selected (S17). In this instance, the process the process transitions to S13 in a case in which “Yes” is selected, and the process transitions to S15 in a case in which “No” is selected.

In the manner described above, the tape printing apparatus 1 of the present embodiment stores a tape classification of the tape cartridge C and a user setting in association with one another, and, when a cartridge is mounted, retrieves the user setting using the tape classification of a mounted tape cartridge C as a key. As a result of this configuration, by merely mounting the tape cartridge C, it is possible to create the same label as a label created in the past without having to perform the input of information at all. For example, if the text “Warning” is stored in association with a tape cartridge C in which a red printing tape T is accommodated, and the text “Caution” is stored in association with a tape cartridge C in which a yellow printing tape T is accommodated, it is possible to instantaneously create a “warning label” or a “caution label” by merely replacing the tape cartridge C. Furthermore, when storing a user setting, since automatic storing is performed in accordance with the execution of printing, it is possible to omit additional labor of a user.

Furthermore, since, in addition to text itself, it is also possible to store text settings as a user setting (edit data), for example, a manner of use in which the character interval is made to be narrow in a case in which a tape cartridge C in which a red printing tape T is accommodated is mounted, and is made to be wide in a case in which a tape cartridge C in which a yellow printing tape T is accommodated is mounted is also possible. Furthermore, since, in addition to the edit data itself, it is also possible to store an environment setting value as a user setting, it is possible to omit additional labor of a user such as setting of the presence or absence of automatic tape cutting and the printing density, and therefore, it is possible to more rapidly create a desired label. In addition, since it is possible to perform the retrieval setting of whether or not to retrieve a user setting when a cartridge is mounted and perform the store setting of whether or not store a user setting when printing is executed in accordance with the preference of a user, the convenience is excellent.

Additionally, it is possible to adopt the following modification examples.

### Modification Example 1

In the above-mentioned embodiment, a tape classification and a user setting is stored in association with one another as a store file, but an identifier (medium information) of the tape cartridge C may be stored in place of a tape classification. According to this configuration, since the tape cartridge C is uniquely specified, even among the same tape classification, it is possible to differentiate uses so that such a tape cartridge C is used for printing of a first text and another tape cartridge C is used for printing of a second text.

### Modification Example 2

In the above-mentioned embodiment, a user setting is stored when printing is executed (“when printing is executed” is used as the second trigger, but), but a user setting may be stored at a time at which opening or closing of the opening/closing lid 21 is detected, when an OFF operation of the power source is performed, or when a store operation is performed by a user. Furthermore, in addition to just the necessity of storing by the store setting unit 81, it may be possible to set the timing at which a user setting is stored.

### Modification Example 3

In addition, a user setting is retrieved when a cartridge is mounted (“when a cartridge is mounted” is used as the first trigger, but), but a user setting may be retrieved at a time at which opening or closing of the opening/closing lid 21 is detected, when an ON operation of the power source is performed, or when a retrieval operation is performed by a user. Furthermore, in addition to just the necessity of retrieval by the retrieval setting unit 82, it may be possible to set the timing at which a user setting is retrieved.

### Modification Example 4

In the above-mentioned embodiment, a user setting is overwritten in a case in which a store file of the same tape classification is already stored, but a confirmation screen for confirming with a user whether or not it is ok to overwrite may be displayed at this time. In addition, as still another modification example, it may be possible to store a plurality of sets of a user setting for a single tape classification. In this case, it is preferable that it be possible to select a user setting when a user setting is retrieved.

### Modification Example 5

In the above-mentioned embodiment, a configuration in which, when the tape cartridge C is mounted, the retrieval of a user setting is not performed (edit data currently being edited is retained) in a case in which there is not a store file that includes the same tape classification as the tape classification of the mounted tape cartridge C, is used, but a configuration in which it is possible to select a user setting of a similar tape classification in a case in which in this manner, there is not a store file that includes the same tape classification is also possible. For example, in a case in which a tape cartridge C in which a red 10 mm-width printing tape T is accommodated is mounted, in a case in which a user setting corresponding to a red 10 mm-width tape classification are not stored, a user setting corresponding to a blue 10 mm-width or a yellow 10 mm-width tape classification may be displayed on the display screen 41 as reflection candidates.

### Second Embodiment

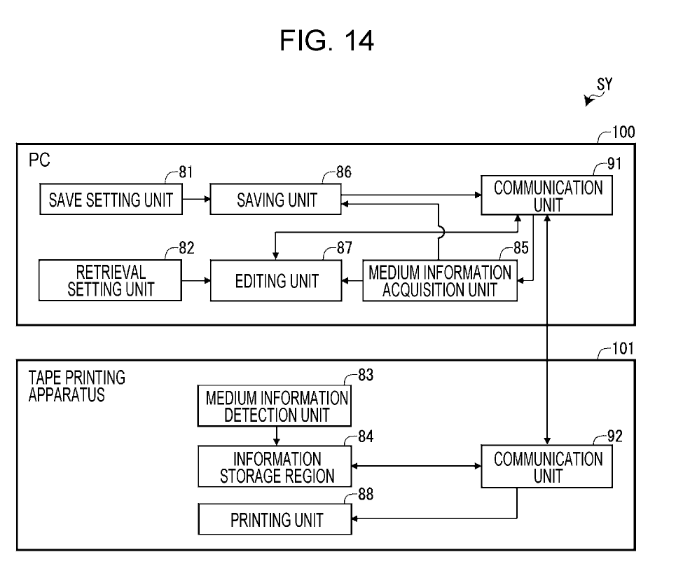

Next, a second embodiment of the invention will be described with reference to FIGS. 14 to 16. In the above-mentioned first embodiment, the information processing device of the invention was applied to the tape printing apparatus 1, but is applied to a PC 100 in the present embodiment. Hereinafter, only features that differ from those of the first embodiment will be described. Additionally, in the present embodiment, similar constituent portions to those of the first embodiment will be given the similar reference numerals, and the detailed descriptions thereof will be omitted. In addition, modification examples that can be applied to similar constituent portions of the first embodiment can also be applied to the present embodiment in a similar manner.

FIG. 14 is a block diagram that shows a functional configuration of a printing system SY according to the second embodiment. The printing system SY of the present embodiment is provided with the PC 100 and a tape printing apparatus 101. A hardware configuration of the PC 100 of the present embodiment is similar to that of a general personal computer, and is provided with display means, input means, storage means, control means, and the like. In addition, a cooperation application for cooperating with the tape printing apparatus 101 is stored in the storage means. Meanwhile, the tape printing apparatus 101 may adopt a similar hardware configuration to that of the tape printing apparatus 1, which is shown in the first embodiment, but a configuration in which the keyboard 3 and the display screen 41 are omitted may also be adopted.

As a functional configuration, the PC 100 is provided with the store setting unit 81, the retrieval setting unit 82, the medium information acquisition unit 85, the storing unit 86, the editing unit 87, and a communication unit 91. These units are functions that a realized by the cooperation application stored in the PC 100. Meanwhile, as a functional configuration, the tape printing apparatus 101 is provided with the medium information detection unit 83, the information storage region 84, the printing unit 88, and a communication unit 92.

The communication units 91 and 92 perform communication between the PC 100 and the tape printing apparatus 101, and connection state (network/1 to 1 connection), communication state (wireless/wired communication), and communication standard thereof are not important. When a tape classification (medium information) is detected, the medium information detection unit 83 of the present embodiment stores the detection result in the information storage region 84 in the tape printing apparatus 101. In addition, the medium information acquisition unit 85 of the present embodiment acquires the tape classification from the tape printing apparatus 101 via the communication units 91 and 92 when the first trigger occurs.

In addition, the editing unit 87 of the present embodiment confirms the retrieval setting, and in a case in which “retrieve” is set, acquires, from the tape printing apparatus 101, a user setting associated with the tape classification acquired beforehand, and reflects the user setting in edit data. In addition, the editing unit 87 generates printing data on the basis of an editing result, and transmits the printing data to the tape printing apparatus 101 via the communication units 91 and 92. Additionally, the tape printing apparatus 101 may transmit a user setting to the PC 100 in accordance with the occurrence of the first trigger, and it may be possible to select whether or not reflect the user setting by displaying the user setting (edit data) on the PC 100 side.

In addition, the medium information acquisition unit 85 of the present embodiment acquires the tape classification from the tape printing apparatus 101 via the communication units 91 and 92 when the second trigger occurs. In addition, the storing unit 86 of the present embodiment generates a store file in which the acquired tape classification and a user setting are associated with one another, and transmits the store file to the tape printing apparatus 101. The tape printing apparatus 101 stores the transmitted stores file in the information storage region 84. Additionally, a configuration in which the tape printing apparatus 101 stores printing data in the information storage region 84 as a user setting (edit data) at a time at which the printing data is received from the PC 100 may also be used.

In the above-mentioned manner, according to the second embodiment, since it is possible to control the store process and the retrieval process of a user setting by using the PC 100, it is possible to reduce the control load of the tape printing apparatus 101, and it is possible to achieve a decrease in the cost of the tape printing apparatus 101.

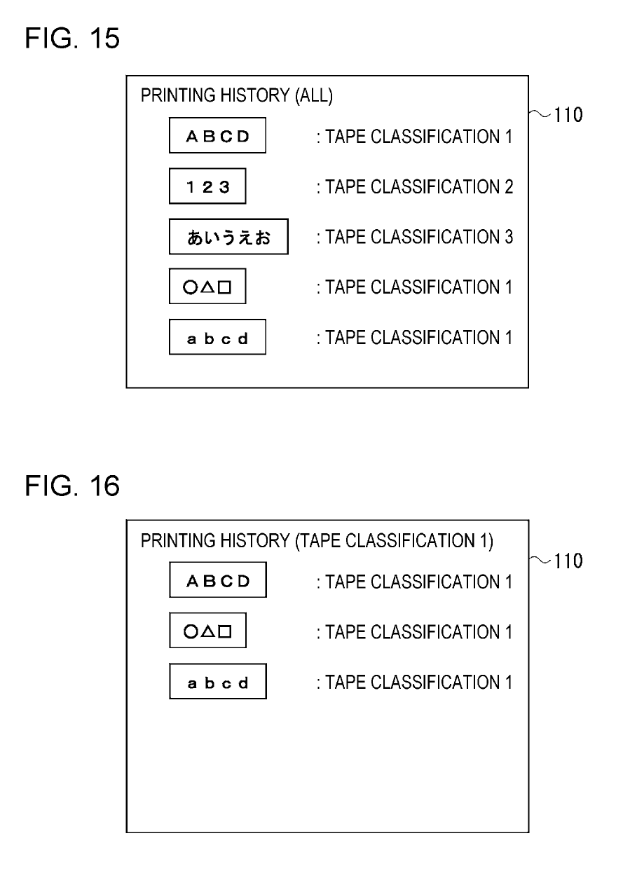

Additionally, in the present embodiment, when a print history is stored in the tape printing apparatus 101, by storing the print history in association with a tape classification, it is possible to display the two types of print history that are shown in FIGS. 15 and 16. FIG. 15 is a view that shows a state in which the entire print history that is stored in the tape printing apparatus 101 is displayed on a display screen 110 of the PC 100. In the drawing, “tape classification *” shows the content (information of tape width, tape color, and the like) of a tape classification. In this manner, the print history is stored in the tape printing apparatus 101 together with the tape classification, and by transferring the print history to the PC 100, it is possible for a user to select a desired candidate from among displayed candidates upon reference to the tape classifications, and to reflect the candidate in edit data.

Meanwhile, FIG. 16 is a view that shows a display example of a print history that is extracted by tape classification. In this manner, by extracting print history by tape classification and displaying the print history, it is possible for a user to easily and rapidly perform the selection of a candidate. Additionally, the extraction of the print history may be performed on the PC 100 side or may be performed on the tape printing apparatus 101 side.

Additionally, it is possible to adopt the following modification examples.

### Modification Example 1

In the above-mentioned second embodiment, the information storage region 84 was provided on the tape printing apparatus 101 side but may be provided on the PC 100 side.

### Modification Example 2

In the above-mentioned second embodiment, when the cooperation application is activated, or when communication with the tape printing apparatus 101 is established may be used as the first trigger.

Two embodiments and modification examples have been shown above, but each constituent element in the tape printing apparatus 1 and the printing system SY shown in the embodiments and modification examples may be provided as a program. In addition, the programs may be provided stored on various recording media (CD-ROM, flash memory, etc.) That is, a program for causing a computer to function as each constituent element of the tape printing apparatus 1 or the printing system SY, a recording medium on which the program is recorded, and labels created by the program are also included in the scope of the rights of the invention. In addition to these, the invention may be altered as appropriate within a range that does not depart from the gist thereof, such as using another information processing terminal such as a tablet terminal in place of the PC 100 of the second embodiment, or realizing each section of the PC 100 by using cloud computing.

1. An information processing device comprising:
a storing unit that stores medium information showing a classification or an identifier of a printing medium and a user setting that includes edit data in association with one another in an information storage region;
a medium information acquisition unit that acquires the medium information of the printing medium that is a printing target; and
an editing unit that retrieves the user setting associated with the acquired medium information from the information storage region and reflects the user setting in the edit data.

2. The information processing device according to claim 1,
wherein the medium information acquisition unit acquires the medium information of the printing medium that is a printing target at a time at which a first trigger occurs, and is provided with a retrieval setting unit that sets necessity of retrieving the user setting, and
the editing unit retrieves the user setting in accordance with the occurrence of the first trigger in a case in which retrieval “required” is set by the retrieval setting unit.

3. The information processing device according to claim 1,
wherein the medium information acquisition unit acquires the medium information of the printing medium that is a printing target when a second trigger occurs, and
the storing unit stores the user setting that includes edit data of the editing unit at a time at which the second trigger occurred, and the medium information acquired at a time at which the second trigger occurred in association with one another.

4. The information processing device according to claim 3, further comprising:
a store setting unit that sets necessity of storing by the storing unit,
the storing unit stores the user setting and the medium information in association with one another in a case in which storing “required” is set by the store setting unit.

5. The information processing device according to claim 3,
wherein the user setting includes an environment setting value at a time at which the second trigger occurred.

6. The information processing device according to claim 1,
wherein the medium information shows a classification of the printing medium, and
the classification of the printing medium is classified by at least one type of information from among a size of the printing medium, a color of the printing medium, a material of the printing medium, or a printing color that can be printed on the printing medium.

7. A tape printing apparatus comprising:
a storing unit that stores medium information showing a classification or an identifier of a tape and a user setting that includes edit data in association with one another in an information storage region;
a medium information acquisition unit that acquires the medium information of the tape that is a printing target;
an editing unit that retrieves the user setting associated with the acquired medium information from the information storage region and reflects the user setting in the edit data; and
a printing unit that performs printing on the tape on the basis of an editing result of the editing unit.

8. An editing method of an information processing device, the method comprising:
a storing step of storing medium information showing a classification or an identifier of a printing medium and a user setting that includes edit data in association with one another in an information storage region;
a medium information acquisition step of acquiring the medium information of the printing medium that is a printing target at a time at which a first trigger occurs; and
an editing step of retrieving the user setting associated with the acquired medium information from the information storage region and reflecting the user setting in the edit data.
